(19) United States
(12) Patent Application Publication
(10) Pub. No.: US 2026/0353264 A1
(43) Pub. Date: Nov. 5, 2026

(54) METHOD AND APPARATUS FOR STAND-ALONE NON-PUBLIC NETWORK RESELECTION IN AUTOMATIC NETWORK SELECTION

(71) Applicant: MEDIATEK INC., Hsinchu City (TW)

(72) Inventors: Chia-Lin LAI, Hsinchu City (TW); Yuan-Chieh LIN, Hsinchu City (TW)

(21) Appl. No.: 19/101,988

(22) PCT Filed: Feb. 2, 2024
(86) PCT No.: PCT/CN2024/075431

§ 371 Date: Feb. 7, 2025

Related U.S. Application Data
(60) Provisional application No. 63/483,541, filed on Feb. 7, 2023.

(51) Int. Cl. H04W 48/18; H04W 60/00

(52) U.S. Cl. CPC H04W 48/18; H04W 60/00

(57) ABSTRACT

Various solutions for stand-alone non-public network (SNPN) reselection in automatic network selection are described. An apparatus may determine that it supports accessing an SNPN providing access for localized services and the apparatus is enabled to access the localized services. Then, the apparatus may determine whether at least one condition associated with SNPN is met. The apparatus may also attempt periodically reselection and registration on a higher priority SNPN, responsive to determining that at least one condition associated with SNPN is met.

### CROSS REFERENCE TO RELATED PATENT APPLICATION(S)

The present disclosure is part of a non-provisional application claiming the priority benefit of U.S. Patent Application No. 63/483,541, filed 7 Feb. 2023, the content of which herein being incorporated by reference in its entirety.

### TECHNICAL FIELD

The present disclosure is generally related to mobile communications and, more particularly, to stand-alone non-public network (SNPN) reselection in automatic network selection.

### BACKGROUND

Unless otherwise indicated herein, approaches described in this section are not prior art to the claims listed below and are not admitted as prior art by inclusion in this section.

A public land mobile network (PLMN) is a network established and operated by an administration or recognized operating agency (ROA) for the specific purpose of providing land mobile communication services to the public. PLMN provides communication possibilities for mobile users. A PLMN may provide service in one or a combination of frequency bands. Access to PLMN services is achieved by means of an air interface involving radio communications between mobile phones and base stations with integrated IP network services. One PLMN may include multiple radio access networks (RANs) utilizing different radio access technologies (RATs) for accessing mobile services. RAN is part of a mobile communication system, which implements a radio access technology. Conceptually, RAN resides between a mobile device and provides connection with its core network (CN). Depending on the (3rd Generation Partnership Project (3GPP)) standards, mobile phones and other wireless connected devices are varyingly known as user equipment (UE), terminal equipment (TE), mobile stations (MS), or mobile termination (MT), etc. Examples of different RATs include 2nd generation (2G) Global System for Mobile Communications (GSM), 3rd generation (3G) Universal Mobile Telecommunications System (UMTS), 4th generation (4G) Long Term Evolution (LTE), 5th generation (5G) New Radio (NR), and other non-3GPP access RAT including Wireless Fidelity (Wi-Fi).

As compared to PLMN, a non-public network (NPN) is a network for non-public use. An NPN is either a stand-alone NPN (SNPN), i.e., operated by an NPN operator and not relying on network functions provided by a PLMN, or a public network integrated NPN (PNI-NPN), i.e., an NPN deployed with the support of a PLMN. A Credentials Holder (CH) may authenticate and authorize access to an SNPN separate from the CH. The combination of a PLMN ID and Network identifier (NID) identifies an SNPN. A UE may be enabled for SNPN, i.e., the UE may be called an SNPN-enabled UE Local or localized services are services that are provided locally (e.g., at specific/limited area and/or are bounded in time). A localized service provider is an application provider or a network operator who make their services localized and to be offered to end user via a hosting network (e.g., an SNPN or a PNI-NPN). A hosting network is a network that provides (access for) localized services, while a home network is a network owning the currently in-use subscription or credential of the UE. End user can enable or disable (the UE) to access localized services. If the end user disables to access localized services, the UE (i.e., MS) may not access an NPN providing access for localized services.

In 3GPP Release 18, it is agreed that the standards for 5G NR will support localized services, but details of how UE can access an SNPN as hosting network have not been fully discussed yet and some issues need to be solved. For example, according to automatic network selection defined in 3GPP standards, the last registered SNPN has the highest priority than other SNPN, which means that a UE will always select and register to the last registered SNPN (if available). However, the last registered SNPN may not be the most preferred SNPN (e.g., the subscribed SNPN, the higher/highest priority SNPN in the CH-controlled prioritized list of preferred SNPNs/group identifiers for network selection (GINs)). That is to say, after the UE is registered to the last registered SNPN, the UE may not leave the registered SNPN to reselect a higher priority SNPN (e.g., subscribed SNPN), unless the user manually selects another SNPN or the registered SNPN is currently unavailable. This may lead to bad user experience or may even cause the user unable to access localized services as desired. Therefore, there is a need to provide proper schemes to solve this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to UE's inability to reselect to a higher priority SNPN in automatic network selection.

In one aspect, a method may involve an apparatus determining that it supports accessing an SNPN providing access for one or more localized services and the apparatus is enabled to access the localized services. The method may also involve the apparatus determining whether at least one condition associated with SNPN is met. The method may further involve the apparatus attempting periodically reselection and registration on a higher priority SNPN, responsive to determining that at least one condition associated with SNPN is met.

In one aspect, an apparatus may comprise a transceiver which, during operation, wirelessly communicates with one or more SNPNs. The apparatus may also comprise a processor communicatively coupled to the transceiver. The processor, during operation, may perform determining that the apparatus supports accessing an SNPN providing access for one or more localized services and the apparatus is enabled to access the localized services. The processor may also perform determining whether at least one condition associated with SNPN is met. The processor may further perform attempting periodically reselection and registration on a higher priority SNPN, responsive to determining that at least one condition associated with SNPN is met.

In one aspect, a method may involve an apparatus determining that it supports accessing an SNPN providing access for one or more localized services and the apparatus is enabled to access the localized services. The method may also involve the apparatus determining whether the apparatus is registered to an SNPN not providing access for the localized services. The method may further involve the apparatus re-attempting an SNPN selection to select an SNPN providing access for the localized services, responsive to determining that the apparatus is registered to an SNPN not providing access for the localized services.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B 5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication system supporting localized services in accordance with implementations of the present disclosure.

FIG. 2 is a diagram depicting two example scenarios of a 5G system (5GS) architecture with access to an SNPN using credentials from a CH.

FIG. 3 is a diagram depicting an example scenario of SNPN subscription data/configuration with validity information in accordance with an implementation of the present disclosure.

FIG. 4 is a diagram depicting another example scenario of SNPN subscription data/configuration with validity information in accordance with an implementation of the present disclosure.

FIG. 5 is a diagram depicting an example scenario of a UE accessing localized services via an SNPN (as hosting network) in accordance with an implementation of the present disclosure.

FIG. 6 is a diagram depicting another example scenario of a UE accessing localized services via an SNPN (as hosting network) in accordance with an implementation of the present disclosure.

FIG. 7 is a diagram depicting an example scenario of SNPN selection order in automatic network selection in accordance with an implementation of the present disclosure.

FIG. 8 is a diagram depicting an example scenario of SNPN reselection in automatic network selection in accordance with an implementation of the present disclosure.

FIG. 9 is a diagram depicting another example scenario of SNPN reselection in automatic network selection in accordance with an implementation of the present disclosure.

FIG. 10 is a diagram depicting another example scenario of SNPN reselection in automatic network selection in accordance with an implementation of the present disclosure.

FIG. 11 is a block diagram of an example communication system in accordance with an implementation of the present disclosure.

FIG. 12 is a flowchart of an example process in accordance with an implementation of the present disclosure.

FIG. 13 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to SNPN reselection in automatic network selection. According to the present disclosure, a number of possible solutions may be implemented separately or jointly. That is, although these possible solutions may be described below separately, two or more of these possible solutions may be implemented in one combination or another.

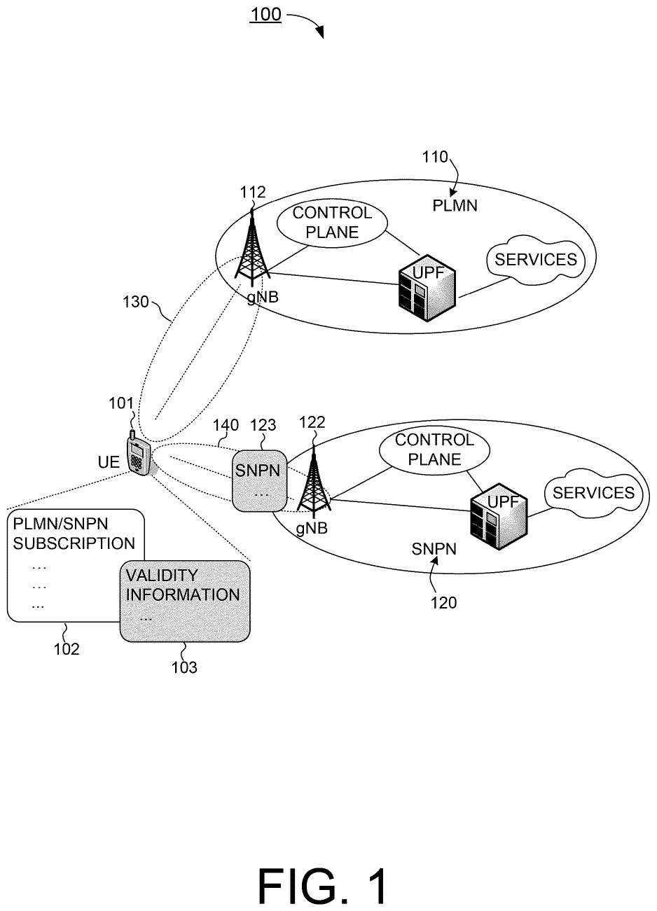

FIG. 1 illustrates an example scenario 100 of a communication system supporting localized services in accordance with implementations of the present disclosure. Scenario 100 involves a communication system including a UE 101, a PLMN 110 and an SNPN 120 providing access for localized services. The PLMN 110 may include control plane functionalities (e.g., an access and mobility management function (AMF)), user plane functionalities (e.g., a user plane function (UPF)), and applications that provide various services by communicating with a plurality of UEs including UE 101. A serving base station (BS) (e.g., the gNB 112) belongs to part of the RAN 130. The RAN 130 provides radio access for the UE 101 via a RAT.

The SNPN 120 may include control plane functionalities (e.g., an AMF), user plane functionalities (e.g., a UPF), and applications that provides various services by communicating with a plurality of UEs including UE 101. The combination of a PLMN ID and NID identifies an SNPN. A serving BS (e.g., the gNB 122) belongs to part of the RAN 140. The RAN 140 provides radio access for the UE 101 via a RAT. An AMF in the SNPN 120 may communicate with gNB 122. The SNPN 120 may be operated by an NPN operator and does not rely on network functions provided by a public network. A CH may authenticate and authorize access to an SNPN separate from the CH. Next-generation RAN (NG-RAN) nodes (e.g., gNB 122) which provide access to SNPNs may broadcast information 123 that includes: (i) one or multiple PLMN IDs; and (ii) a list of NIDs per PLMN ID identifying the NPNs which the NG-RAN provides access to. An SNPN-enabled UE (e.g., UE 101) may be configured with PLMN ID and NID (i.e., configured with an SNPN ID=PLMN ID+NID) of the subscribed SNPN. An SNPN-enabled UE that supports access to an SNPN using credentials from a CH may additionally be configured with information for SNPN selection (SNPN selection information/configuration), and may perform registration using the PLMN/SNPN subscription 102 (e.g., stored in a universal subscriber identity module (USIM)) (in SNPN access mode).

Local or localized services are services that are provided locally (e.g., at specific/limited area and/or are bounded in time (e.g., specific time period(s), such as specific date(s) or specific hours of date(s)). The services may be realized via applications (e.g., live or on-demand audio/video stream, electric game, IP multimedia subsystem (IMS), etc.), or connectivity (e.g., UE to UE, UE to Data Network, etc.). A localized service provider may be an application provider or a network operator who makes their services localized and to be offered to end user via a hosting network. A hosting network may be a network that provides access for localized services and can be an SNPN or a PNI-NPN, while a home network is a network owning the currently in-use subscription or credential of the UE. In scenario 100, the SNPN 120 is the hosting network providing access for localized services to the UE 101.

A UE route selection policy (URSP) rule may include an association of the UE application and the DNN or network slice which is meant for a specific localized service. A URSP rule can also include “Route Selection Validity Criteria” (Time Window and/or a Location Criteria Validity Conditions) with the time/location defined for the specific localized service. The LADN (Local Access Data Network) can also be used for enabling the UE access to localized service.

To enable the SNPN 120 to provide access to localized services, the SNPN operator may configure the network with information enabling the UEs to access the localized services according to validity of the localized services, and the information is determined in agreement with the localized service provider. For instance, the validity information may include: (i) identification of each localized service, e.g., to be used in URSP rules; and (ii) validity criteria/restriction for each localized service, e.g., the validity of time period and/or (area of) location.

When localized services in a network are completed/over, all UEs registered with the network are expected to be moved to other networks or to other cells within the same network. The other networks may each be a home PLMN (HPLMN), visited PLMN (VPLMN) or another SNPN. A UE may stop using the network resources for localized services for numerous reasons, such as: (i) localized services in a network are completed; (ii) validity conditions of network selection information are no longer met; (iii) the user decides to stop using the localized services before they are completed (e.g., end user disables to access localized services); and (iv) a policy decision is taken by the network, with the effect that the UE is deregistered before the localized services are completed. The validity information 103 (or called validity restrictions, criteria, or conditions) is provided or configured to the UE 101 as part of the localized service information, which is used to restrict the UE's access of the SNPN (as hosting network) providing access for localized services.

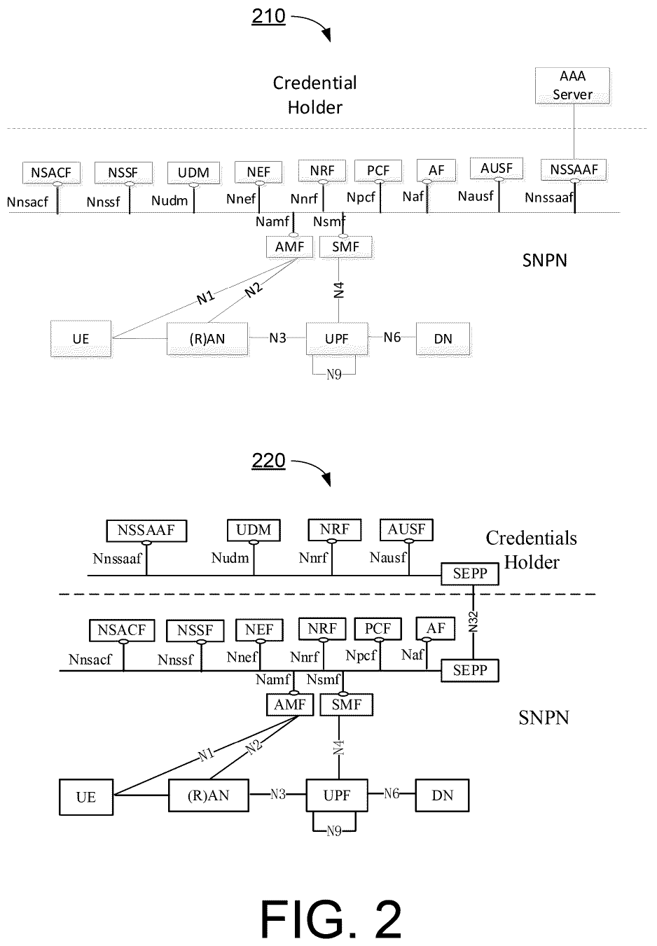

FIG. 2 illustrates two example scenarios 210 and 220 of a 5GS architecture with access to an SNPN using credentials from a CH. Scenario 210 depicts the 5GS architecture for SNPN with CH using authentication, authorization and accounting (AAA) server for primary authentication and authorization. The authentication server function (AUSF) and unified data management (UDM) in an SNPN may support primary authentication and authorization of UEs using credentials from an AAA server in a CH. The SNPN, as depicted by 210, can be the subscribed SNPN for the UE (i.e., the NG-RAN broadcasts the SNPN ID of the subscribed SNPN). As a deployment option, the SNPN, as depicted by 210, can also be another SNPN than the subscribed SNPN for the UE (i.e., none of the SNPN IDs broadcast by the NG-RAN matches the SNPN ID corresponding to the subscribed SNPN). The network slice-specific and SNPN authentication and authorization function (NSSAAF) deployed in the SNPN can support primary authentication in the SNPN using credentials from a CH using an AAA server (as depicted) and/or the NSSAAF can support NSSAAF with a network slice-specific AAA server (not depicted).

Scenario 220 depicts the 5GS architecture for SNPN with CH using AUSF and UDM for primary authentication and authorization. An SNPN may support primary authentication and authorization of UEs that use credentials from a CH using AUSF and UDM. The CH may be an SNPN or a PLMN. The CH UDM provides to SNPN the subscription data.

### SNPN As Hosting Network Providing Access for Localized Services

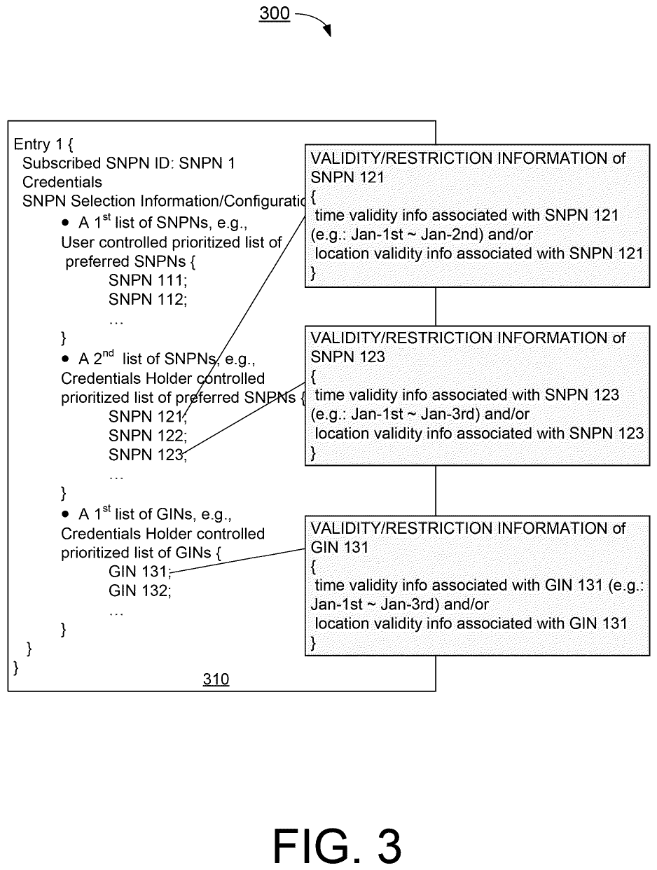

FIG. 3 illustrates an example scenario 300 of SNPN subscription data/configuration with validity information in accordance with an implementation of the present disclosure. Scenario 300 depicts an exemplary SNPN subscription data/configuration that an SNPN-enabled UE may be configured with for selecting and accessing an SNPN for localized services. For a UE accessing an SNPN (as hosting network) using the subscription/credentials of its home network, only two cases are considered. If the home network (or CH) is a PLMN, the hosting network can be a PNI-NPN or an SNPN. If the home network (or CH) is an SNPN, the hosting network can only be an SNPN. If the UE accesses the hosting network using subscriptions or credentials from the UE's home network, and the UE has multiple credentials or subscriptions, then the UE may need to determine which credential or subscription to be used to access the hosting network. The validity information provided to the UE as part of the localized service information can be used to restrict the UE's access of the hosting network. For example, the validity information may include: (time and/or location) validity information or conditions information ((time and/or location:) duration, criteria, or restriction) associated with SNPN (ID) or GIN.

As depicted by 310, an SNPN-enabled UE may be configured with the following information for each subscribed SNPN: (i) PLMN ID and NID (SNPN ID) of the subscribed SNPN (e.g., SNPN 1); and (ii) subscription permanent identifier (SUPI) and credentials for the subscribed SNPN. If the UE supports access to an SNPN using credentials from a CH, then the UE may also be configured with: (iii) user-controlled prioritized list of preferred SNPNs (e.g., SNPN 111, SNPN 112); (iv) CH-controlled prioritized list of preferred SNPNs (e.g., SNPN 121, SNPN 122, SNPN 123); and (v) CH-controlled prioritized list of GINs (e.g., GIN 131, GIN 132).

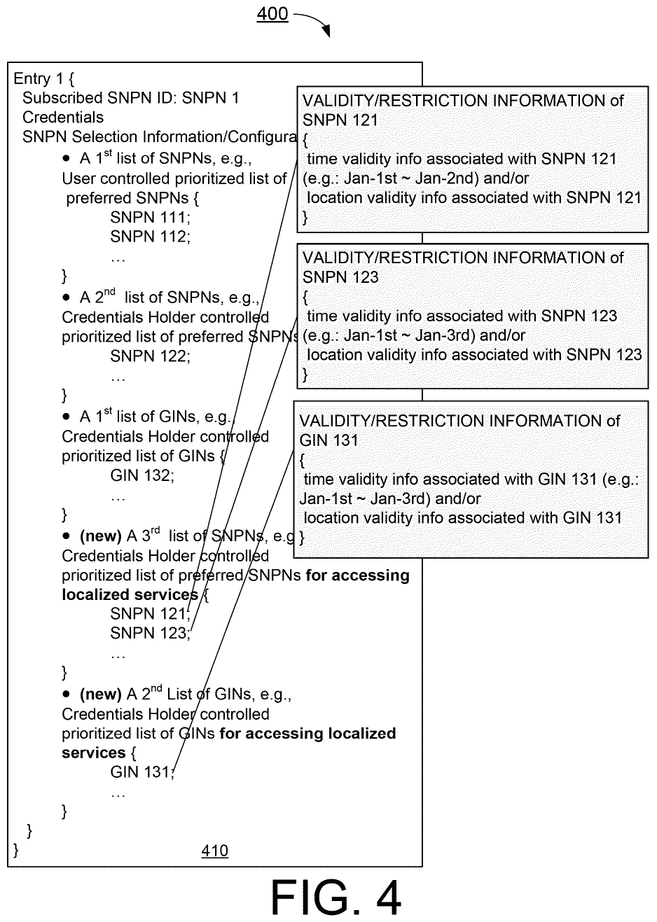

FIG. 4 illustrates an example scenario 400 of SNPN subscription data/configuration with validity information in accordance with an implementation of the present disclosure. Scenario 400 depicts another exemplary SNPN subscription data/configuration that an SNPN-enabled UE may be configured with for selecting and accessing an SNPN for localized services. For automatic network selection, in the case of SNPN (as hosting network) for localized services, there can be associated (time (duration) and/or location (restriction)) validity information for SNPN(s) or GIN(s). In one example, as depicted by 310, the existing CH-controlled prioritized list of preferred SNPNs (and GINs) can be extended with the (time and/or location) validity information or conditions information for each entry in the list; or in another example, as depicted by 410, there can be one (or more) new list type defined to provide entries with validity information for SNPNs and GINs (i.e., to define new CH-controlled prioritized lists of preferred SNPNs/GINs for accessing localized services, where each entry contains an SNPN/GIN identity and validity information/conditions).

As depicted by 310 or 410, SNPN 121 has associated time (duration/period) validity condition (the time duration/period (e.g., start and end time) in which the UE is allowed to access SNPN 121) of January-1st~January-2nd, SNPN 123 has associated time (duration/period) validity condition of January-1st~January-3rd, and GIN 131 has associated time (duration/period) validity condition of January-1st~January-3rd. Such time (duration/period) validity/conditions information may be provided to the UE as part of the localized service information to restrict the UE's access of the hosting network for localized services. Additionally, or optionally, the validity/conditions information may also include location validity/conditions information, which can be in the form of geolocation and/or tracking area identity (TAI)(s) or cell(s) (of serving network (serving PLMN or serving SNPN)), such that the location validity/conditions information may be used to assist the UE to determine where to start searching for SNPNs as hosting networks.

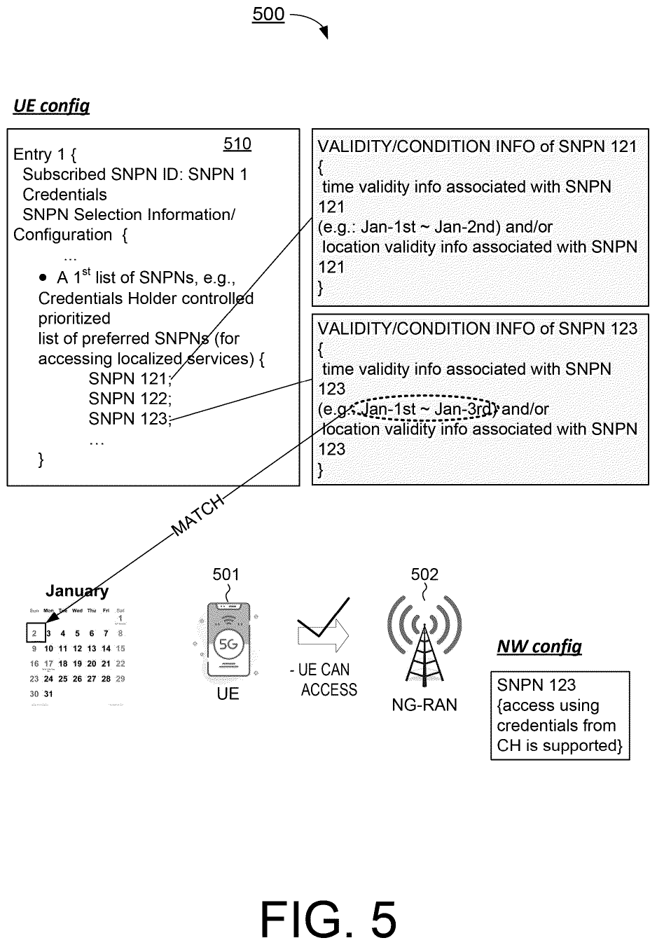

FIG. 5 illustrates an example scenario 500 of a UE accessing localized services via an SNPN (as hosting network) in accordance with an implementation of the present disclosure. Scenario 500 depicts the access of an SNPN-enabled UE 501 to an SNPN (as hosting network) (e.g., SNPN 123) in a time period is accepted. The UE 501 is configured with SNPN subscription 510 including: (i) the subscribed SNPN=SNPN 1; and (ii) CH-controlled prioritized list of preferred SNPNs (for accessing localized services), which includes SNPN 121, SNPN 122, and SNPN 123. Specifically, SNPN 121 is associated with time validity condition of January-1st~January-2nd, and SNPN 123 is associated with time validity condition of January-1st~January-3rd. Through 5GC/AMF and the NG-RAN 502, the hosting network SNPN 123 broadcasts its SNPN ID==123, with an indication that access using credentials from a CH is supported. Since the UE 501 is subscribed to SNPN 1, and SNPN 123 is included as a preferred SNPN in the entry of “list of subscriber data” for SNPN1, the UE 501 may select and attempt to access SNPN 123 using credentials from SNPN 1. That is, SNPN 123 is a localized service provider and a hosting network, while SNPN 1 is the credential holder. Since there exists a time validity condition associated with SNPN 123, the UE 501 needs to determine whether such time validity condition is met before the access. The UE 501 checks the current time being January 2nd, which is inside the time period of January-1st~January-3rd. As a result, the UE 501 can access SNPN 123 using credentials from the subscribed SNPN 1. Additionally, or optionally, if location validity information is available, in this example we assume location validity condition is met per the location validity information.

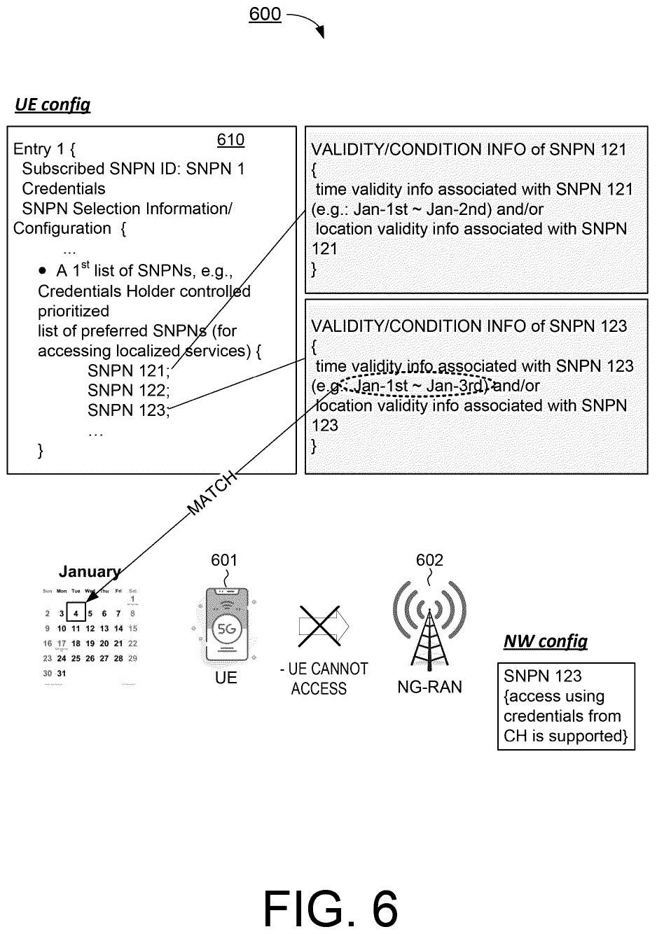

FIG. 6 illustrates an example scenario 600 of a UE accessing localized services via an SNPN (as hosting network) in accordance with an implementation of the present disclosure. Scenario 600 depicts the access of an SNPN-enabled UE 601 to an SNPN (as hosting network) (e.g., SNPN 123) in another time period is not allowed (i.e., if the UE tries to access, the network will reject). The UE 601 is configured with the SNPN subscription 610 including: (i) the subscribed SNPN=SNPN 1; and (ii) a CH-controlled prioritized list of preferred SNPNs, which includes SNPN 121, SNPN 122, and SNPN 123. Specifically, SNPN 121 is associated with time validity condition of January-1st~January-2nd, and SNPN 123 is associated with time validity condition of January-1st~January-3rd. Through 5GC/AMF and the NG-RAN 602, the hosting network SNPN 123 broadcasts its SNPN ID==123, with an indication that access using credentials from a CH is supported. Since the UE 601 is subscribed to SNPN 1, and SNPN 123 is included as a preferred SNPN in the entry of “list of subscriber data” for SNPN1, the UE 601 may select and attempt to access SNPN 123. Since there exist a time validity condition associated with SNPN 123, the UE 601 needs to determine whether such time validity condition is met before the access. The UE 601 checks the current time being January 4th, which is outside the time period of January-1st~January-3rd. As a result, the UE 601 cannot access SNPN 123 using credentials from SNPN 1.

### Automatic Network Selection for Supporting Localized Services

An SNPN-enabled UE supports to access SNPN (in the SNPN access mode). When a UE is configured to operate in the SNPN access mode, it only selects and registers with SNPNs. Moreover, when a UE is configured to operate in the SNPN access mode, the UE does not perform normal PLMN selection procedures. There are two network (e.g., SNPN) selection procedures, including automatic network (e.g., SNPN) selection procedure and manual network (e.g., SNPN) selection procedure. Specifically, the automatic network (e.g., SNPN) selection is enhanced/adapted in which an order for SNPN selection is provided with considerations of validity information (configured for localized services) and UE/NW capability regarding the support of access using credentials from a CH.

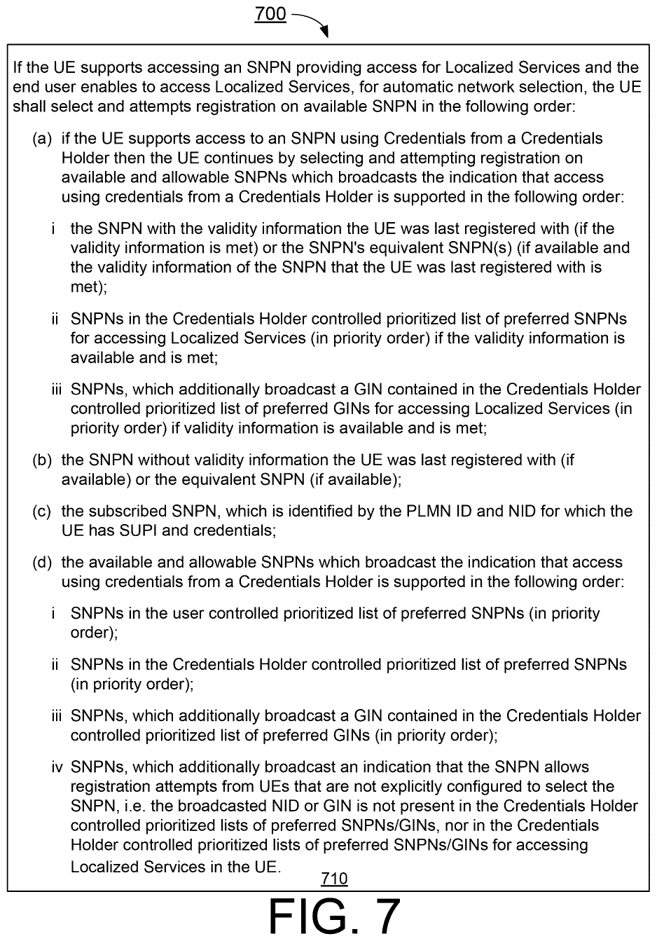

FIG. 7 illustrates an example scenario 700 of SNPN selection order in automatic network selection in accordance with an implementation of the present disclosure. As depicted by 710, if the UE supports to access an SNPN as hosting network (i.e., the UE supports accessing an SNPN providing access for localized services) and the localized services access mode is enabled (i.e., the end user enables (the UE) to access localized services), the UE selects and attempts registration on available SNPN in the following order: (a) if the UE supports access to an SNPN using credentials from a CH, then the UE continues by selecting and attempting registration on available and allowable SNPNs, which broadcast the indication that access using credentials from a CH is supported, in the following order: (i) (if there is a stored registered SNPN which is a hosting network) the SNPN providing access for localized services (i.e., the SNPN with the validity information), that the UE was last registered with (if the validity information is met) or the SNPN's equivalent SNPN(s) (if available and the validity information of the SNPN that the UE was last registered with is met); (ii) SNPNs with validity information in the CH-controlled prioritized list of preferred SNPNs (e.g., SNPNs in the CH-controlled prioritized list of preferred SNPNs for accessing localized services) (in priority order) if the validity information is available and is met; (iii) SNPNs, which additionally broadcast a GIN with validity information contained in the CH-controlled prioritized list of preferred GINs (e.g., a GIN contained in the CH-controlled prioritized list of preferred GINs for accessing localized services) (in priority order) if validity information is available and is met; (b) (if there is a stored registered SNPN which is a non-hosting network) the SNPN as non-hosting network (i.e., the SNPN without validity information) that the UE was last registered with or the SNPN's equivalent SNPN(s) (if available); (c) the subscribed SNPN, which is identified by the PLMN ID and NID for which the UE has SUPI and credentials; (d) the available and allowable SNPNs which broadcast the indication that access using credentials from a CH is supported in the following order: (i) SNPNs in the user-controlled prioritized list of preferred SNPNs (in priority order); (ii) SNPNs in the CH-controlled prioritized list of preferred SNPNs (in priority order); (iii) SNPNs, which additionally broadcast a GIN contained in the CH-controlled prioritized list of preferred GINs (in priority order); (iv) SNPNs, which additionally broadcast an indication that the SNPN allows registration attempts from UEs that are not explicitly configured to select the SNPN, i.e. the broadcasted NID or GIN is not present in the CH-controlled prioritized lists of preferred SNPNs/GINs, nor in the CH-controlled prioritized lists of preferred SNPNs/GINs for accessing Localized Services in the UE.

Otherwise, if the UE does not support to access an SNPN as hosting network (i.e., the UE does not support to access an SNPN providing access for localized services) or the localized services access mode is not enabled (i.e., the end user does not enable (the UE) to access the localized services), the UE selects and attempts registration on available and allowable SNPNs in the following order (not depicted): (1) (if there is a stored registered SNPN which is a non-hosting network) the SNPN as non-hosting network (i.e., the SNPN without validity information) that the UE was last registered with or the SNPN's equivalent SNPN(s) (if available); (2) the subscribed SNPN, which is identified by the PLMN ID and NID for which the UE has SUPI and credentials; (3) if the UEs supports access to an SNPN using credentials from a CH, then the UE continues by selecting and attempting registration on available and allowable SNPNs, which broadcast the indication that access using credentials from a CH is supported, in the following order: (i) SNPNs in the user-controlled prioritized list of preferred SNPNs (in priority order); (ii) SNPNs (without validity information) in the CH-controlled prioritized list of preferred SNPNs (in priority order); (iii) SNPNs, which additionally broadcast a GIN (without validity information) contained in the Credentials Holder controlled prioritized list of preferred GINs (in priority order); (iv) SNPNs, which additionally broadcast an indication that the SNPN allows registration attempts from UEs that are not explicitly configured to select the SNPN, i.e. the broadcasted NID or GIN is not present in the CH-controlled prioritized lists of preferred SNPNs/GINs in the UE.

### SNPN Reselection in Automatic Network Selection

According to automatic network selection defined in 3GPP standards (e.g., Release 17/18), the last registered SNPN has the highest priority than other SNPN, which means that a UE will always select and register to the last registered SNPN (if available). However, the registered SNPN may not be the most preferred SNPN (e.g., the subscribed SNPN, the higher/highest priority SNPN in the CH-controlled prioritized list of preferred SNPNs/group identifiers for network selection (GINs)). That is to say, the UE may not leave the registered SNPN to reselect a higher priority SNPN (e.g., subscribed SNPN), unless the user manually selects another SNPN or the registered SNPN is currently unavailable. This may lead to bad user experience or may even cause the user unable to access localized services as desired. Therefore, there is a need to provide proper schemes to solve this issue.

Under proposed schemes in accordance with the present disclosure, the automatic network selection is enhanced/adapted to include explicit UE operations regarding SNPN reselection. Specifically, re-attempt(s) of SNPN selection (i.e., periodical attempts of SNPN reselection) is/are allowed under certain condition(s) (e.g., when condition(s) associated with SNPN or condition associated with currently registered SNPN's capability of supporting localized services is/are met). Accordingly, by applying the schemes of the present disclosure, a UE may reselect to a higher priority SNPN to access localized services with better user experience.

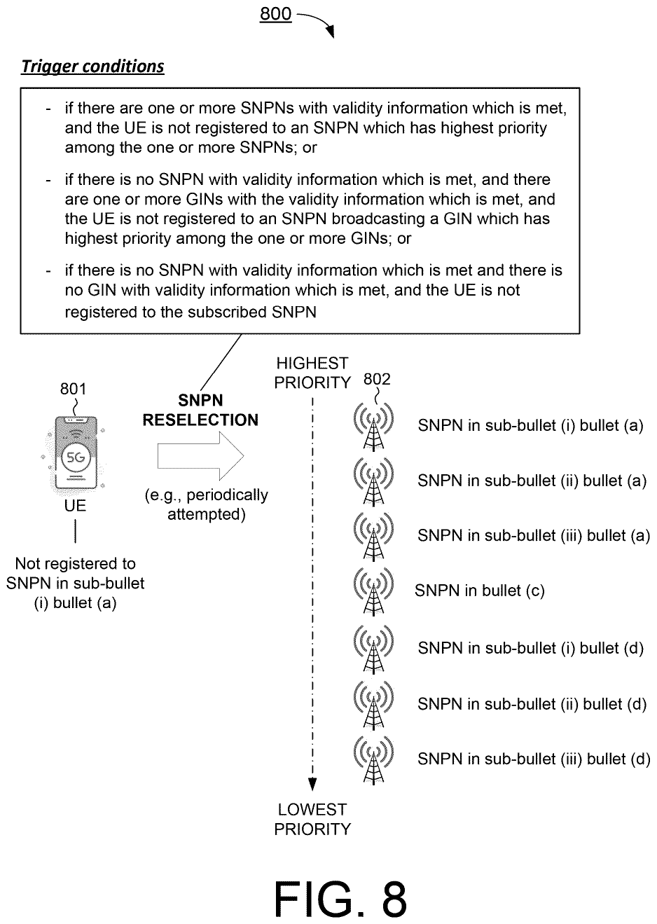

FIG. 8 illustrates an example scenario 800 of SNPN reselection in automatic network selection in accordance with an implementation of the present disclosure. Scenario 800 depicts a specific order of SNPN reselection in a UE 801 that is not registered to the sub-bullet (i) of bullet (a) as depicted in 710, i.e., the UE 801 is not registered to the last registered SNPN with validity information that is met or the SNPN's equivalent SNPN. Specifically, the UE 801 supports accessing an SNPN providing access for localized services and the end user enables to access localized services. The SNPN reselection may be attempted periodically with a fixed periodicity (e.g., every hour) or with a varied periodicity (e.g., an hour before the first attempt, two hours before the second attempt, and four hours before the third attempt, etc.). The trigger conditions for the SNPN reselection may include: (1) there are one or more SNPNs with validity information which is met, and the UE 801 is not registered to an SNPN which has highest priority among the one or more SNPNs; (2) there is no SNPN with validity information which is met, and there are one or more GINs with the validity information which is met, and the UE 801 is not registered to an SNPN broadcasting a GIN which has highest priority among the one or more GINs; and (3) there is no SNPN with validity information which is met and there is no GIN with validity information which is met, and the UE 801 is not registered to a subscribed SNPN. The SNPN reselection may be attempted if any of the trigger conditions is met. More specifically, the UE 801 attempts periodically reselection and registration on a higher priority SNPN 802 based on the order of sub-bullets (i) to (iii) of bullet (a), bullet (c), sub-bullets (i) to (iii) of bullet (d) as depicted in 710.

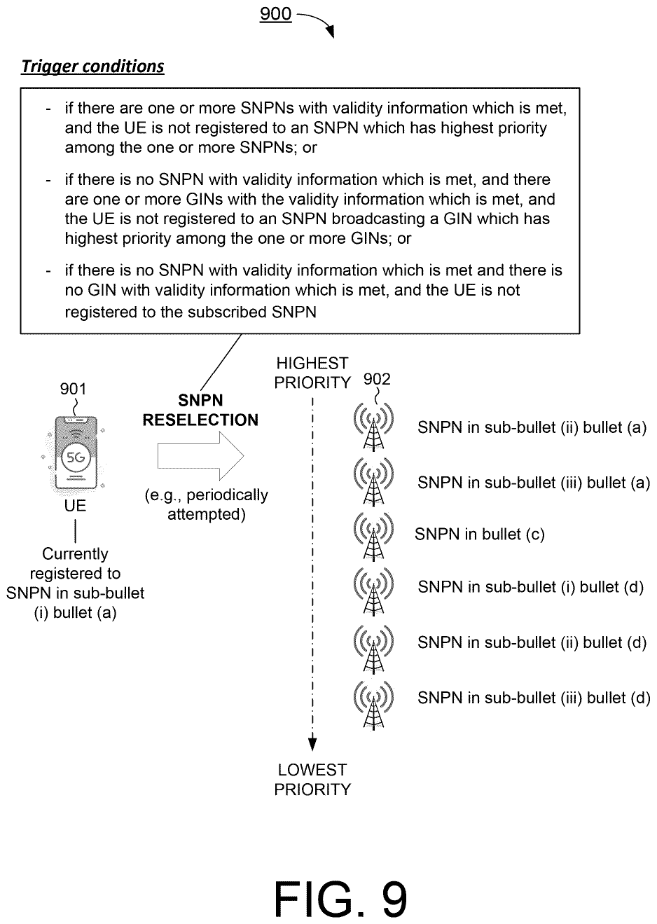

FIG. 9 illustrates an example scenario 900 of SNPN reselection in automatic network selection in accordance with an implementation of the present disclosure. Scenario 900 depicts a specific order of SNPN reselection in a UE 901 that is currently registered to the sub-bullet (i) of bullet (a) as depicted in 710, i.e., the UE 901 is registered to the last registered SNPN with validity information that is met or the SNPN's equivalent SNPN. Specifically, the UE 901 supports accessing an SNPN providing access for localized services and the end user enables to access localized services. Similar to scenario 800, the SNPN reselection may be attempted periodically with a fixed or varied periodicity, and the SNPN reselection may be attempted if any of the trigger conditions is met. More specifically, the UE 901 attempts periodically reselection and registration on a higher priority SNPN 902 based on the order of sub-bullets (ii) to (iii) of bullet (a), bullet (c), sub-bullets (i) to (iii) of bullet (d) as depicted in 710.

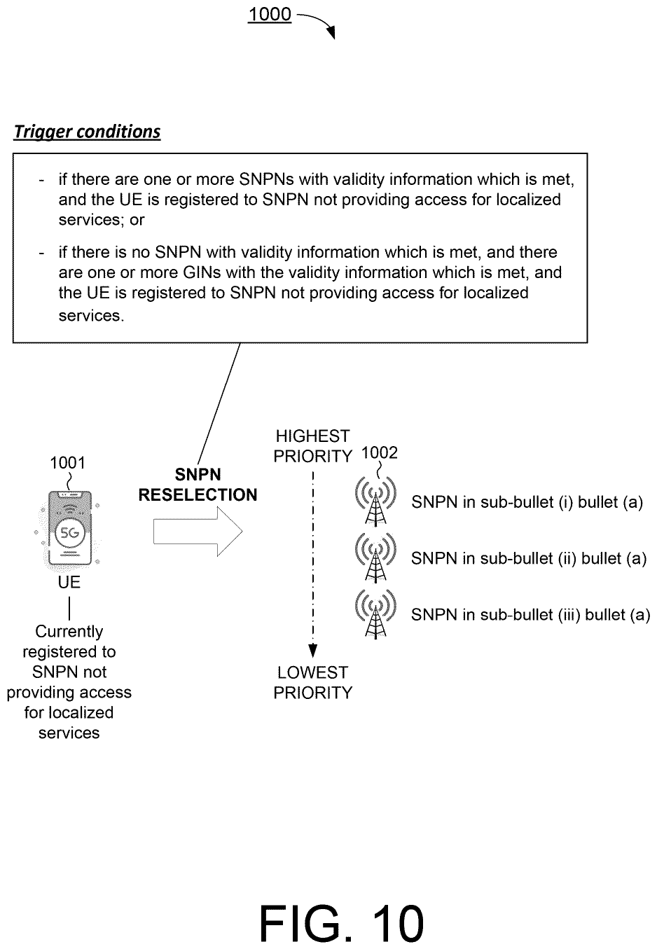

FIG. 10 illustrates an example scenario 1000 of SNPN reselection in automatic network selection in accordance with an implementation of the present disclosure. Scenario 1000 depicts a specific order of SNPN reselection in a UE 1001 that is registered to an SNPN not providing access for localized services. Specifically, the UE 1001 supports accessing an SNPN providing access for localized services and the end user enables to access localized services. The trigger conditions for the SNPN reselection may include: (1) there are one or more SNPNs with validity information which is met, and the UE 1001 is registered to an SNPN not providing access for localized services; and (2) there is no SNPN with validity information which is met, and there are one or more GINs with the validity information which is met, and the UE 1001 is registered to an SNPN not providing access for localized services. The SNPN reselection may be attempted if any of the trigger conditions is met. More specifically, the UE 1001 re-attempts SNPN selection and registration on a higher priority SNPN 1002 based on the order of sub-bullets (i) to (iii) of bullet (a) as depicted in 710. The time interval for triggering the re-attempt (and subsequent re-attempts, if still required) may be determined by the UE 1001 in an implementation specific way, and the scope of the present disclosure should not be limited thereto.

### Illustrative Implementations

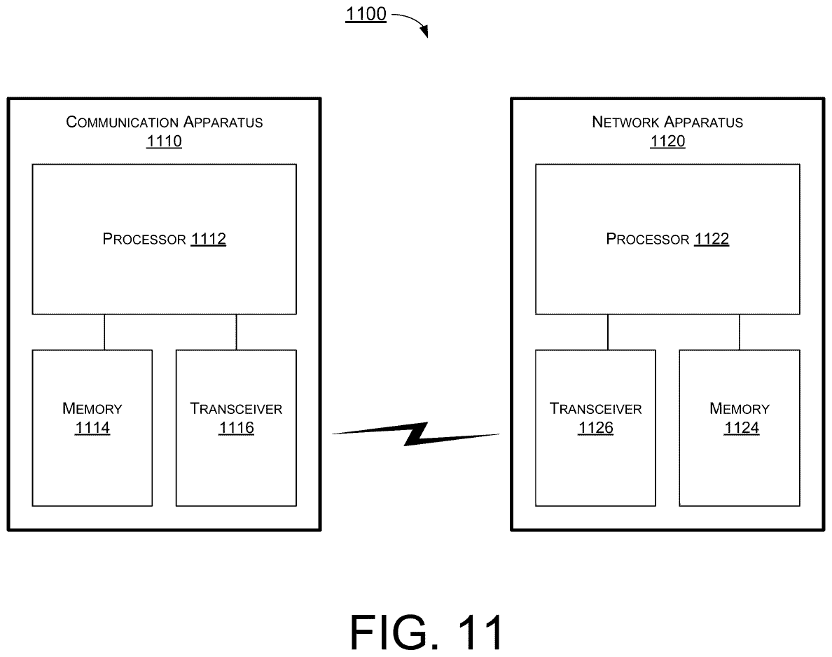

FIG. 11 illustrates an example communication system 1100 having an example communication apparatus 1110 and an example network apparatus 1120 in accordance with an implementation of the present disclosure. Each of communication apparatus 1110 and network apparatus 1120 may perform various functions to implement schemes, techniques, processes and methods described herein pertaining to SNPN reselection in automatic network selection, including scenarios/schemes described above as well as processes 1200 and 1300 described below.

Communication apparatus 1110 may be a part of an electronic apparatus, which may be a UE such as a portable or mobile apparatus, a wearable apparatus, a wireless communication apparatus or a computing apparatus. For instance, communication apparatus 1110 may be implemented in a smartphone, a smartwatch, a personal digital assistant, a digital camera, or a computing equipment such as a tablet computer, a laptop computer or a notebook computer. Communication apparatus 1110 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1110 may be implemented in a smart thermostat, a smart fridge, a smart door lock, a wireless speaker or a home control center. Alternatively, communication apparatus 1110 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1110 may include at least some of those components shown in FIG. 11 such as a processor 1112, for example. Communication apparatus 1110 may further include one or more other components not pertinent to the proposed scheme of the present disclosure (e.g., internal power supply, display device and/or user interface device), and, thus, such component(s) of communication apparatus 1110 are neither shown in FIG. 11 nor described below in the interest of simplicity and brevity.

Network apparatus 1120 may be a part of an electronic apparatus, which may be a network node such as a BS, a small cell, a router or a gateway. For instance, network apparatus 1120 may be implemented in an eNodeB in an LTE, LTE-Advanced or LTE-Advanced Pro network or in a gNB in a 5G, NR, IoT, NB-IoT or IIoT network. More specifically, network apparatus 1120 may belong to part of an RAN of an SNPN. Alternatively, network apparatus 1120 may be implemented in the form of one or more IC chips such as, for example and without limitation, one or more single-core processors, one or more multi-core processors, or one or more RISC or CISC processors. Network apparatus 1120 may include at least some of those components shown in FIG. 11 such as a processor 1122, for example. Network apparatus 1120 may further include one or more other components not pertinent to the proposed scheme of the present disclosure (e.g., internal power supply, display device and/or user interface device), and, thus, such component(s) of network apparatus 1120 are neither shown in FIG. 11 nor described below in the interest of simplicity and brevity.

In one aspect, each of processor 1112 and processor 1122 may be implemented in the form of one or more single-core processors, one or more multi-core processors, or one or more CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including SNPN reselection in automatic network selection in a device (e.g., as represented by communication apparatus 1110) in accordance with various implementations of the present disclosure.

In some implementations, communication apparatus 1110 may also include a transceiver 1116 coupled to processor 1112 and capable of wirelessly transmitting and receiving data. In some implementations, communication apparatus 1110 may further include a memory 1114 coupled to processor 1112 and capable of being accessed by processor 1112 and storing data (e.g., the ID(s) of the last registered SNPN, the equivalent SNPN(s), the CH-controlled prioritized list of preferred SNPNs (for accessing localized services), and/or CH-controlled prioritized list of preferred GINs (for accessing localized services)) therein. In some implementations, network apparatus 1120 may also include a transceiver 1126 coupled to processor 1122 and capable of wirelessly transmitting and receiving data. In some implementations, network apparatus 1120 may further include a memory 1124 coupled to processor 1122 and capable of being accessed by processor 1122 and storing data therein. Accordingly, communication apparatus 1110 and network apparatus 1120 may wirelessly communicate with each other via transceiver 1116 and transceiver 1126, respectively. To aid better understanding, the following description of the operations, functionalities and capabilities of each of communication apparatus 1110 and network apparatus 1120 is provided in the context of a mobile communication environment in which communication apparatus 1110 is implemented in or as a communication apparatus or a UE and network apparatus 1120 is implemented in or as a network node of a communication network.

According to certain proposed schemes of the present disclosure, processor 1112 may determine that communication apparatus 1110 supports accessing an SNPN providing access for one or more localized services and communication apparatus 1110 is enabled to access the localized services. Then, processor 1112 may determine whether at least one condition associated with SNPN is met. Responsive to determining that at least one condition associated with SNPN is met, processor 1112 may attempt periodically reselection and registration on a higher priority SNPN.

In some implementations, the at least one condition associated with SNPN may include: (1) there are one or more SNPNs with validity information which is met, and communication apparatus 1110 is not registered to an SNPN which has highest priority among the one or more SNPNs; (2) there is no SNPN with validity information which is met, and there are one or more GINs with the validity information which is met, and communication apparatus 1110 is not registered to an SNPN broadcasting a GIN which has highest priority among the one or more GINs; and (3) there is no SNPN with validity information which is met and there is no GIN with validity information which is met, and communication apparatus 1110 is not registered to a subscribed SNPN.

In some implementations, processor 1112 may further determine not to trigger periodic reselection and not to attempt registration on a higher priority SNPN, responsive to determining that no condition associated with SNPN is met.

In some implementations, in an event that communication apparatus 1110 is not registered to a last registered SNPN with validity information that is met or an equivalent SNPN, the higher priority SNPN is reselected in the following order: (1) the last registered SNPN with validity information that is met or the equivalent SNPN; (2) an SNPN with validity information that is met among SNPNs with validity information in a list of preferred SNPNs; or (3) an SNPN with validity information that is met from SNPNs, each of which broadcasts a GIN with validity information contained in a list of preferred GINs. Additionally, or optionally, in an event that there is no SNPN with validity information that is met, the higher priority SNPN is reselected further in the following order: (4) a subscribed SNPN that is identified by a PLMN ID and a NID for which communication apparatus 1110 has a SUPI and credentials; or (5) an SNPN which broadcasts an indication that access using credentials from a CH is supported, wherein the SNPN is selected in the following order: (i) an SNPN with highest priority in a user-controlled prioritized list of preferred SNPNs; (ii) an SNPN with highest priority in a CH-controlled prioritized list of preferred SNPNs; or (iii) an SNPN with highest priority among SNPNs, each of which broadcasts a GIN contained in a CH-controlled prioritized list of preferred GINs.

In some implementations, in an event that communication apparatus 1110 is registered to a last registered SNPN with validity information that is met or an equivalent SNPN, the higher priority SNPN is reselected in the following order: (1) an SNPN with validity information that is met among SNPNs with validity information in a list of preferred SNPNs; or (2) an SNPN with validity information that is met from SNPNs, each of which broadcasts a GIN with validity information contained in a list of preferred GINs. Additionally, or optionally, in an event that there is no SNPN with validity information that is met, the higher priority SNPN is reselected further in the following order: (3) a subscribed SNPN that is identified by a PLMN ID and a NID for which the apparatus has a SUPI and credentials; or (4) an SNPN which broadcasts an indication that access using credentials from a CH is supported, wherein the SNPN is selected in the following order: (i) an SNPN with highest priority in a user-controlled prioritized list of preferred SNPNs; (ii) an SNPN with highest priority in a CH-controlled prioritized list of preferred SNPNs; or (iii) an SNPN with highest priority among SNPNs, each of which broadcasts a GIN contained in a CH-controlled prioritized list of preferred GINs.

According to certain proposed schemes of the present disclosure, processor 1112 may determine that communication apparatus 1110 supports accessing an SNPN providing access for one or more localized services and communication apparatus 1110 is enabled to access the localized services. Then, processor 1112 may determine whether communication apparatus 1110 is registered to an SNPN not providing access for the localized services. Responsive to determining that communication apparatus 1110 is registered to an SNPN not providing access for the localized services, processor 1112 may re-attempt an SNPN selection to select an SNPN providing access for the localized services.

In some implementations, the re-attempting of the SNPN selection is performed in an event that at least one of the following conditions associated with SNPN is met: (1) there are one or more SNPNs with validity information which is met; and (2) there are one or more GINs with the validity information which is met.

In some implementations, the SNPN providing access for the localized services is selected in the following order: (1) the last registered SNPN with validity information that is met or the equivalent SNPN; (2) an SNPN with validity information that is met among SNPNs with validity information in a list of preferred SNPNs; or (3) an SNPN with validity information that is met from SNPNs, each of which broadcasts a GIN with validity information contained in a list of preferred GINs.

In some implementations, the validity information may include time validity information, and the validity information is met when the time validity information includes at least one time period matching communication apparatus 1110′s current time.

In some implementations, processor 1112 may further re-attempt a registration on the selected SNPN.

### Illustrative Processes

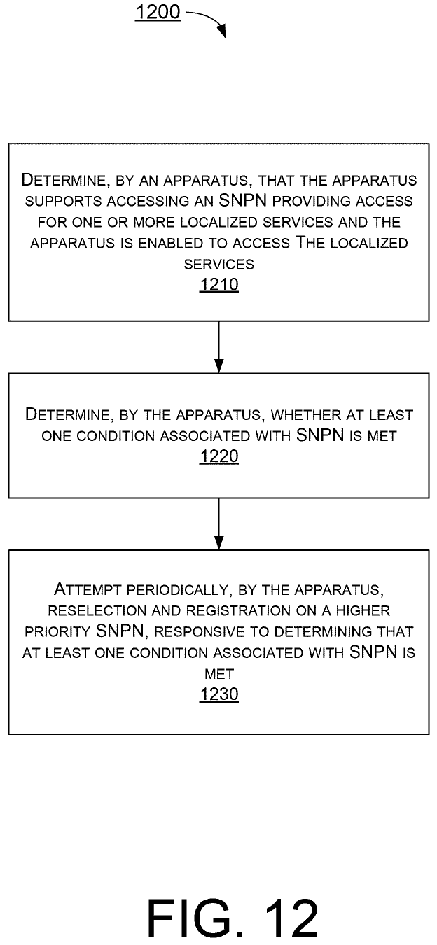

FIG. 12 illustrates an example process 1200 in accordance with an implementation of the present disclosure. Process 1200 may be an example implementation of above scenarios/schemes, whether partially or completely, with respect to SNPN reselection in automatic network selection. Process 1200 may represent an aspect of implementation of features of communication apparatus 1110. Process 1200 may include one or more operations, actions, or functions as illustrated by one or more of blocks 1210 to 1230. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Process 1200 may be implemented by communication apparatus 1110 or any suitable UE or machine type devices. Solely for illustrative purposes and without limitation, process 1200 is described below in the context of communication apparatus 1110. Process 1200 may begin at block 1210.

At 1210, process 1200 may involve (processor 1112 of) communication apparatus 1110 determining that communication apparatus 1110 supports accessing an SNPN providing access for one or more localized services and communication apparatus 1110 is enabled to access the localized services. Process 1200 may proceed from 1210 to 1220.

At 1220, process 1200 may involve (processor 1112 of) communication apparatus 1110 determining whether at least one condition associated with SNPN is met. Process 1200 may proceed from 1220 to 1230.

At 1230, process 1200 may involve (processor 1112 of) communication apparatus 1110, responsive to determining that at least one condition associated with SNPN is met, attempting periodically reselection and registration on a higher priority SNPN.

In some implementations, the at least one condition associated with SNPN may include: (1) there are one or more SNPNs with validity information which is met, and communication apparatus 1110 is not registered to an SNPN which has highest priority among the one or more SNPNs; (2) there is no SNPN with validity information which is met, and there are one or more GINs with the validity information which is met, and communication apparatus 1110 is not registered to an SNPN broadcasting a GIN which has highest priority among the one or more GINs; and (3) there is no SNPN with validity information which is met and there is no GIN with validity information which is met, and communication apparatus 1110 is not registered to a subscribed SNPN.

In some implementations, process 1200 may further involve (processor 1112 of) communication apparatus 1110 determining not to trigger periodic reselection and not to attempt registration on a higher priority SNPN, responsive to determining that no condition associated with SNPN is met.

In some implementations, in an event that communication apparatus 1110 is not registered to a last registered SNPN with validity information that is met or an equivalent SNPN, the higher priority SNPN is reselected in the following order: (1) the last registered SNPN with validity information that is met or the equivalent SNPN; (2) an SNPN with validity information that is met among SNPNs with validity information in a list of preferred SNPNs; or (3) an SNPN with validity information that is met from SNPNs, each of which broadcasts a GIN with validity information contained in a list of preferred GINs. Additionally, or optionally, in an event that there is no SNPN with validity information that is met, the higher priority SNPN is reselected further in the following order: (4) a subscribed SNPN that is identified by a PLMN ID and a NID for which communication apparatus 1110 has a SUPI and credentials; or (5) an SNPN which broadcasts an indication that access using credentials from a CH is supported, wherein the SNPN is selected in the following order: (i) an SNPN with highest priority in a user-controlled prioritized list of preferred SNPNs; (ii) an SNPN with highest priority in a CH-controlled prioritized list of preferred SNPNs; or (iii) an SNPN with highest priority among SNPNs, each of which broadcasts a GIN contained in a CH-controlled prioritized list of preferred GINs.

In some implementations, in an event that communication apparatus 1110 is registered to a last registered SNPN with validity information that is met or an equivalent SNPN, the higher priority SNPN is reselected in the following order: (1) an SNPN with validity information that is met among SNPNs with validity information in a list of preferred SNPNs; or (2) an SNPN with validity information that is met from SNPNs, each of which broadcasts a GIN with validity information contained in a list of preferred GINs. Additionally, or optionally, in an event that there is no SNPN with validity information that is met, the higher priority SNPN is reselected further in the following order: (3) a subscribed SNPN that is identified by a PLMN ID and a NID for which the apparatus has a SUPI and credentials; or (4) an SNPN which broadcasts an indication that access using credentials from a CH is supported, wherein the SNPN is selected in the following order: (i) an SNPN with highest priority in a user-controlled prioritized list of preferred SNPNs; (ii) an SNPN with highest priority in a CH-controlled prioritized list of preferred SNPNs; or (iii) an SNPN with highest priority among SNPNs, each of which broadcasts a GIN contained in a CH-controlled prioritized list of preferred GINs.

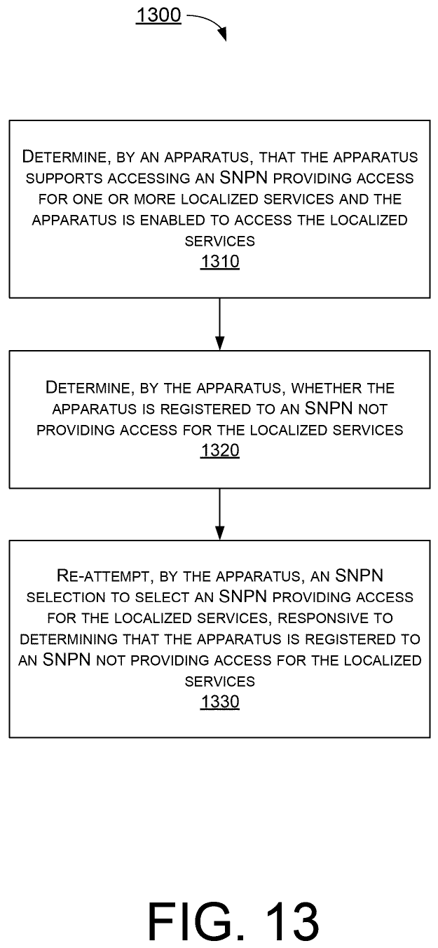

FIG. 13 illustrates an example process 1300 in accordance with an implementation of the present disclosure. Process 1300 may be an example implementation of above scenarios/schemes, whether partially or completely, with respect to SNPN reselection in automatic network selection. Process 1300 may represent an aspect of implementation of features of communication apparatus 1110. Process 1300 may include one or more operations, actions, or functions as illustrated by one or more of blocks 1310 to 1330. Although illustrated as discrete blocks, various blocks of process 1300 may be divided into additional blocks, combined into fewer blocks, or eliminated, depending on the desired implementation. Moreover, the blocks of process 1300 may be executed in the order shown in FIG. 13 or, alternatively, in a different order. Process 1300 may be implemented by communication apparatus 1110 or any suitable UE or machine type devices. Solely for illustrative purposes and without limitation, process 1300 is described below in the context of communication apparatus 1110. Process 1300 may begin at block 1310.

At 1310, process 1300 may involve (processor 1112 of) communication apparatus 1110 determining that communication apparatus 1110 supports accessing an SNPN providing access for one or more localized services and communication apparatus 1110 is enabled to access the localized services. Process 1300 may proceed from 1310 to 1320.

At 1320, process 1300 may involve (processor 1112 of) communication apparatus 1110 determining whether communication apparatus 1110 is registered to an SNPN not providing access for the localized services. Process 1300 may proceed from 1320 to 1330.

At 1330, process 1300 may involve (processor 1112 of) communication apparatus 1110 re-attempting an SNPN selection to select an SNPN providing access for the localized services, responsive to determining that communication apparatus 1110 is registered to an SNPN not providing access for the localized services.

In some implementations, the re-attempting of the SNPN selection is performed in an event that at least one of the following conditions associated with SNPN is met: (1) there are one or more SNPNs with validity information which is met; and (2) there are one or more GINs with the validity information which is met.

In some implementations, the SNPN providing access for the localized services is selected in the following order: (1) the last registered SNPN with validity information that is met or the equivalent SNPN; (2) an SNPN with validity information that is met among SNPNs with validity information in a list of preferred SNPNs; or (3) an SNPN with validity information that is met from SNPNs, each of which broadcasts a GIN with validity information contained in a list of preferred GINs.

In some implementations, the validity information may include time validity information, and the validity information is met when the time validity information includes at least one time period matching communication apparatus 1110′s current time.

In some implementations, process 1300 may also involve (processor 1112 of) communication apparatus 1110 re-attempting a registration on the selected SNPN.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by an apparatus, that the apparatus supports accessing a stand-alone non-public network (SNPN) providing access for one or more localized services and the apparatus is enabled to access the localized services ;
determining, by the apparatus, whether at least one condition associated with SNPN is met; and
attempting periodically, by the apparatus, reselection and registration on a higher priority SNPN, responsive to determining that at least one condition associated with SNPN is met.

2. The method of claim 1, wherein the at least one condition associated with SNPN comprises:
there are one or more SNPNs with validity information which is met, and the apparatus is not registered to an SNPN which has highest priority among the one or more SNPNs;
there is no SNPN with validity information which is met, and there are one or more group identifiers for network selection (GINs) with the validity information which is met, and the apparatus is not registered to an SNPN broadcasting a GIN which has highest priority among the one or more GINs; and
there is no SNPN with validity information which is met and there is no GIN with validity information which is met, and the apparatus is not registered to a subscribed SNPN.

3. The method of claim 1, further comprising:
determining, by the apparatus, not to trigger periodic reselection and not to attempt registration on a higher priority SNPN, responsive to determining that no condition associated with SNPN is met.

4. The method of claim 1, wherein, in an event that the apparatus is not registered to a last registered SNPN with validity information that is met or an equivalent SNPN, the higher priority SNPN is reselected in the following order:
the last registered SNPN with validity information that is met or the equivalent SNPN;
an SNPN with validity information that is met among SNPNs with validity information in a list of preferred SNPNs; or
an SNPN with validity information that is met from SNPNs, each of which broadcasts a group identifier for network selection (GIN) with validity information contained in a list of preferred GINs.

5. The method of claim 4, wherein, in an event that there is no SNPN with validity information that is met, the higher priority SNPN is reselected in the following order:
a subscribed SNPN that is identified by a public land mobile network (PLMN) identifier (ID) and a network identifier (NID) for which the apparatus has a subscription permanent identifier (SUPI) and credentials; or
an SNPN which broadcasts an indication that access using credentials from a credentials holder (CH) is supported, wherein the SNPN is selected in the following order:
an SNPN with highest priority in a user-controlled prioritized list of preferred SNPNs;
an SNPN with highest priority in a CH-controlled prioritized list of preferred SNPNs; or
an SNPN with highest priority among SNPNs, each of which broadcasts a GIN contained in a CH-controlled prioritized list of preferred GINs.

6. The method of claim 1, wherein, in an event that the apparatus is registered to a last registered SNPN with validity information that is met or an equivalent SNPN, the higher priority SNPN is reselected in the following order:
an SNPN with validity information that is met among SNPNs with validity information in a list of preferred SNPNs; or
an SNPN with validity information that is met from SNPNs, each of which broadcasts a group identifier for network selection (GIN) with validity information contained in a list of preferred GINs.

7. The method of claim 6, wherein, in an event that there is no SNPN with validity information that is met, the higher priority SNPN is reselected in the following order:
a subscribed SNPN that is identified by a public land mobile network (PLMN) identifier (ID) and a network identifier (NID) for which the apparatus has a subscription permanent identifier (SUPI) and credentials; or
an SNPN which broadcasts an indication that access using credentials from a credentials holder (CH) is supported, wherein the SNPN is selected in the following order:
an SNPN with highest priority in a user-controlled prioritized list of preferred SNPNs;
an SNPN with highest priority in a CH-controlled prioritized list of preferred SNPNs; or
an SNPN with highest priority among SNPNs, each of which broadcasts a GIN contained in a CH-controlled prioritized list of preferred GINs.

8. An apparatus, comprising:
a transceiver which, during operation, wirelessly communicates with one or more stand-alone non-public networks (SNPNs); and
a processor, communicatively coupled to the transceiver, which during operation, performs:
determining that the apparatus supports accessing an SNPN providing access for one or more localized services and the apparatus is enabled to access the localized services;
determining whether at least one condition associated with SNPN is met; and
attempting periodically reselection and registration on a higher priority SNPN, responsive to determining that at least one condition associated with SNPN is met.

9. The apparatus of claim 8, wherein the at least one condition associated with SNPN comprises:
there are one or more SNPNs with validity information which is met, and the apparatus is not registered to an SNPN which has highest priority among the one or more SNPNs;
there is no SNPN with validity information which is met, and there are one or more group identifiers for network selection (GINs) with the validity information which is met, and the apparatus is not registered to an SNPN broadcasting a GIN which has highest priority among the one or more GINs; or
there is no SNPN with validity information which is met and there is no GIN with validity information which is met, and the apparatus is not registered to a subscribed SNPN.

10. The apparatus of claim 8, wherein, during operation, the processor further performs:
determining not to trigger periodic reselection and not to attempt registration on a higher priority SNPN, responsive to determining that no condition associated with SNPN is met.

11. The apparatus of claim 8, wherein, in an event that the apparatus is not registered to a last registered SNPN with validity information that is met or an equivalent SNPN, the higher priority SNPN is reselected in the following order:
the last registered SNPN with validity information that is met or the equivalent SNPN;
an SNPN with validity information that is met among SNPNs with validity information in a list of preferred SNPNs; or
an SNPN with validity information that is met from SNPNs, each of which broadcasts a group identifier for network selection (GIN) with validity information contained in a list of preferred GINs.

12. The apparatus of claim 11, wherein, in an event that there is no SNPN with validity information that is met, the higher priority SNPN is reselected in the following order:
a subscribed SNPN that is identified by a public land mobile network (PLMN) identifier (ID) and a network identifier (NID) for which the apparatus has a subscription permanent identifier (SUPI) and credentials; or
an SNPN which broadcasts an indication that access using credentials from a credentials holder (CH) is supported, wherein the SNPN is selected in the following order:
an SNPN with highest priority in a user-controlled prioritized list of preferred SNPNs;
an SNPN with highest priority in a CH-controlled prioritized list of preferred SNPNs; or
an SNPN with highest priority among SNPNs, each of which broadcasts a GIN contained in a CH-controlled prioritized list of preferred GINs.

13. The apparatus of claim 8, wherein, in an event that the apparatus is registered to a last registered SNPN with validity information that is met or an equivalent SNPN, the higher priority SNPN is reselected in the following order:
an SNPN with validity information that is met among SNPNs with validity information in a list of preferred SNPNs; or
an SNPN with validity information that is met from SNPNs, each of which broadcasts a group identifier for network selection (GIN) with validity information contained in a list of preferred GINs.

14. The apparatus of claim 13, wherein, in an event that there is no SNPN with validity information that is met, the higher priority SNPN is reselected in the following order:
a subscribed SNPN that is identified by a public land mobile network (PLMN) identifier (ID) and a network identifier (NID) for which the apparatus has a subscription permanent identifier (SUPI) and credentials; or
an SNPN which broadcasts an indication that access using credentials from a credentials holder (CH) is supported, wherein the SNPN is selected in the following order:
an SNPN with highest priority in a user-controlled prioritized list of preferred SNPNs;
an SNPN with highest priority in a CH-controlled prioritized list of preferred SNPNs; or
an SNPN with highest priority among SNPNs, each of which broadcasts a GIN contained in a CH-controlled prioritized list of preferred GINs.

15. A method, comprising:
determining, by an apparatus, that the apparatus supports accessing a stand-alone non-public network (SNPN) providing access for one or more localized services and the apparatus is enabled to access the localized services; and
determining, by the apparatus, whether the apparatus is registered to an SNPN not providing access for the localized services; and
re-attempting, by the apparatus, an SNPN selection to select an SNPN providing access for the localized services, responsive to determining that the apparatus is registered to an SNPN not providing access for the localized services.

16. The method of claim 15, wherein the re-attempting of the SNPN selection is performed in an event that at least one of the following conditions associated with SNPN is met:
there are one or more SNPNs with validity information which is met; and
there are one or more group identifiers for network selection (GINs) with the validity information which is met.

17. The method of claim 16, wherein the validity information comprises time validity information, and the validity information is met when the time validity information comprises at least one time period matching the apparatus' current time.

18. The method of claim 15, wherein the SNPN providing access for the localized services is selected in the following order:
the last registered SNPN with validity information that is met or the equivalent SNPN;
an SNPN with validity information that is met among SNPNs with validity information in a list of preferred SNPNs; or
an SNPN with validity information that is met from SNPNs, each of which broadcasts a group identifier for network selection (GIN) with validity information contained in a list of preferred GINs.

19. The method of claim 18, wherein the validity information comprises time validity information, and the validity information is met when the time validity information comprises at least one time period matching the apparatus' current time.

20. The method of claim 15, further comprising:
re-attempting, by the apparatus, a registration on the selected SNPN.
